(19) United States
(12) Patent Application Publication
(10) Pub. No.: US 2010/0215876 A1
(43) Pub. Date: Aug. 26, 2010

(54) Multi-wrap wrap-around label and container having such a label

(76) Inventor: Peter Seidl, Munich (DE)

Correspondence Address: COLLARD & ROE, P.C., 1077 NORTHERN BOULEVARD, ROSLYN, NY, 11576, US

(21) Appl. No.: 12/660,359

(22) Filed: Feb. 25, 2010

(30) Foreign Application Priority Data
Feb. 26, 2009 (DE) 10 2009 001 206.0

(51) Int. Cl. G09F 3/02; B32B 1/02; G09F 3/10; B32B 3/10

(52) U.S. Cl. 428/34.1; 428/137; 428/43

(57) ABSTRACT

A multi-wrap wrap-around label is able to make a plurality of wings and/or documentation parts available. The wing parts can be provided with information on one or both sides. The documentation parts are also provided with information and are configured to be removable. By wrapping a container with a proposed label, multiple times, a structure is formed that is able to accommodate a number of wing and/or documentation parts on a small container. Furthermore, a container is described that is provided with the proposed label. A container labeled in this manner can be equipped with a large amount of information.

### CROSS REFERENCE TO RELATED APPLICATIONS

Applicant claims priority under 35 U.S.C. §119 of German Application No. 10 2009 001 206.0 filed Feb. 26, 2009.

### BACKGROUND OF THE INVENTION

1. Field of the Invention

The present invention relates to a multi-wrap wrap-around label for labeling containers. The label has at least one material layer that has an underside that is adhesive at least at certain points and a top side that carries information. The invention also relates to a container connected with such a label.

2. The Prior Art

A label of the type stated is known from EP 0946936 B1. This reference describes a label having multiple removable documentation sections. In this connection, the label is larger than the circumference of the container onto which the label is supposed to be applied. Thus, the label comes to lie partly on itself after it has been dispensed. In order to make the removable documentation parts available, the label according to this reference must be provided with a special sub-structure that gives the label the required stability and allows removal of the documentation parts.

In the medical sector, in particular, there is an increasing need to make comprehensive information available on the label of a small container. Removable documentation sections, of which generally at least two are provided, usually carry only an expiration date and a lot number. In this connection, the individual documentation section, despite the comparatively small amount of information that it carries, must have a minimum size that allows easy handling of the documentation section (removing the self-adhesive documentation section and pasting it into a documentation record). These documentation sections are generally imprinted by machine by the pharmaceutical manufacturers, just before the label is dispensed onto a container. As a result, the documentation sections must also have a size that permits a certain error tolerance in placement of the imprint. Recently, pharmaceutical manufacturers increasingly desire to have labels that have not just two but rather three or more documentation sections. All these requirements lead to the result that in the case of small containers, the predominant part of the mantle surface of the container is easily lost, in a certain way, for the documentation sections, and that hardly any room remains available for other information that is important from a medical point of view.

Pharmaceutical products that require documentation are generally offered for sale in so-called single-dose containers. They can be equipped with removable parts that can be written on. There are also, however, so-called multi-dose containers, to a very great extent, both for vaccines and for other products such as anesthetics, from which up to ten portions are removed. In this case, too, documentation with one or two removable parts is desired. All of the versions known up to now fail to accomplish the task of making a sufficient area available for an even larger number of removable parts, which can be written on, in the dispenser, with lot number and expiration date. In general, the number is limited by the circumference of the container.

### SUMMARY OF THE INVENTION

It is an object of the present invention to provide a label having a theoretically unlimited number of documentation parts that can be written on and easily pulled off. The area of the mantle of a container generally limits the number of removable parts. In the case of products in multi-dose containers, however, a plurality of removable parts that can be written on is required. Here, a wish can exist for up to twenty or even more removable parts.

The label must fulfill the requirements of law concerning labeling during use, in other words over a relatively long period of time. In other words, all the essential components must be maintained, even if parts of the label have to be removed, again and again, during use. It must be possible to instruct even untrained persons, who do not have any special knowledge concerning use, in handling of the product and the label. It must be possible to process the label, in its entirety, in fully automated manner, on existing dispensing systems. It must be possible to write on the surface of all removable parts and also on the information part, for example using thermo-transfer printing or a laser printer.

These and other objects are achieved according to the invention by a multi-wrap wrap-around label and a container labeled with same in which the material layer has at least one punched-out sheet that can be folded out of the material layer.

When the label passes through the dispensing device, where all the data are imprinted (e.g. expiration date and lot number), the label is laid around the container multiple times. After labeling, the label can be opened and the sheet or all the sheets stand up and allow a view of all the parts. By appropriate punching, weakening lines can be produced, which can be used to produce the number of removable parts required, in each instance. After each removal process, the label is closed again. Further advantageous embodiments are discussed below.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a top view showing a first exemplary embodiment of a multi-wrap wrap-around label according to the invention;

FIG. 2 is a perspective view showing a cylindrical container that is labeled with the multi-wrap wrap-around label from FIG. 1, wherein the multi-wrap wrap-around label is partly pulled off;

FIG. 3 is a top view showing a second exemplary embodiment of a multi-wrap wrap-around label according to the invention;

FIG. 4 is a top view showing a third exemplary embodiment of a multi-wrap wrap-around label according to the invention;

FIG. 5 is a top view showing a cylindrical container that is labeled with the multi-wrap wrap-around label from FIG. 4, wherein the multi-wrap wrap-around label is partly pulled off;

FIG. 6 is a top view showing a fourth exemplary embodiment of a multi-wrap wrap-around label according to the invention;

FIG. 7 is a top view showing a cylindrical container that is labeled with the multi-wrap wrap-around label from FIG. 6, wherein the multi-wrap wrap-around label is partly pulled off;

FIG. 8 is a top view showing a fifth exemplary embodiment of a multi-wrap wrap-around label according to the invention; and

FIG. 9 is a top view showing a container that is square in cross-section, which is labeled with a multi-wrap wrap-around label from FIG. 8, wherein the multi-wrap wrap-around label is partly pulled off.

### DETAILED DESCRIPTION OF PREFERRED EMBODIMENTS

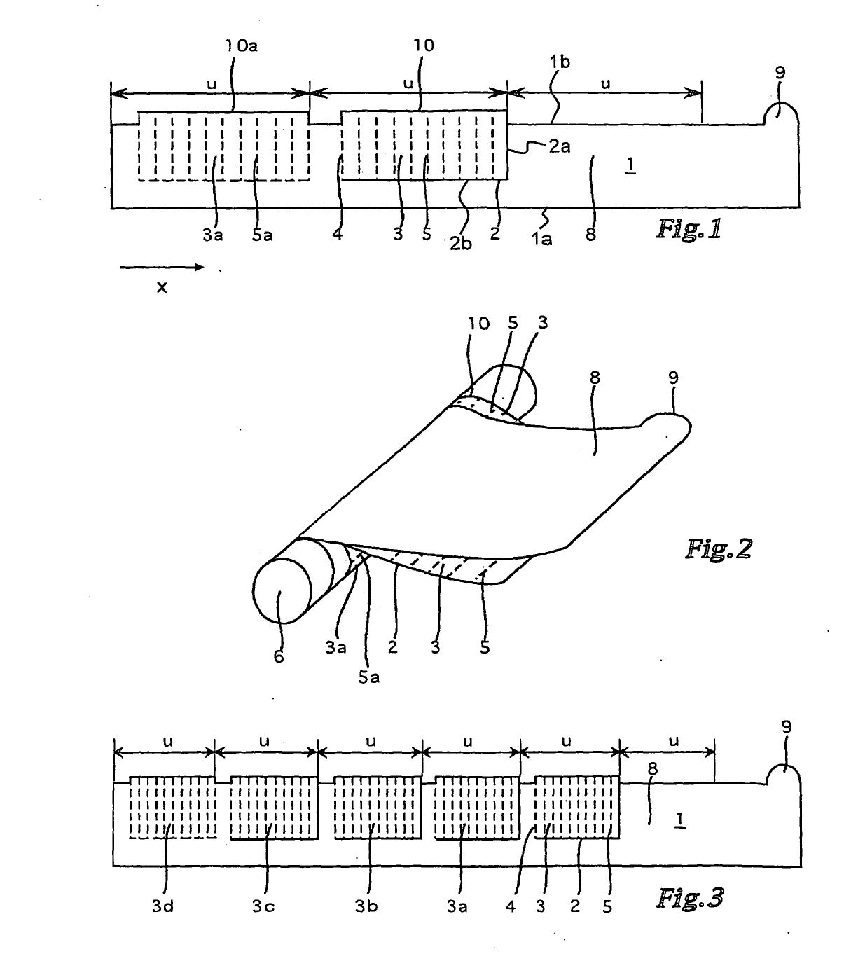

FIG. 1 shows a multi-wrap wrap-around label having a material layer 1 that is coated with an adhesive on its underside, at least at certain points. Using an L-shaped punching 2, which extends all the way to the edge of material layer 1, a rectangular sheet 3 is produced, which is connected with the remainder of material layer 1 by way of a fold line 4. Sheet 3 can be folded out of material layer 1 or set upright, whereby it is rotated about fold line 4, by way of which it is connected with material layer 1. Sheet 3 is divided into strips by multiple weakening lines 5, and these strips can be removed individually or several at a time, in order to use them for documentation purposes. Weakening lines 5 are generally implemented by perforation punchings. Other types of weakening lines, for example at least partial cutting of the film layer or the like, are also possible.

L-shaped punching 2 has a first section 2a, which runs crosswise, for example perpendicular to the main expanse direction x of the label. In the exemplary embodiment shown in FIG. 1, first section 2a of the L-shaped punching runs crosswise, i.e. perpendicular to the edge 1a of material layer 1 that is shown at the bottom, extending from left to right. A second section 2b of the L-shaped punching runs crosswise, for example perpendicular to first section 2a, and parallel to the aforementioned edge 1a of material layer 1 in the exemplary embodiment. Fold line 4, in turn, runs crosswise, for example perpendicular to the aforementioned edge 1a of material layer 1, and thus parallel to first section 2a of the L-shaped punching.

In the weakening lines 5 configured as perforation punchings in the example, punched sections and non-punched sections alternate along the weakening line, in each instance. In the exemplary embodiment, L-shaped punching 2 is a punching that is continuous along the entire L shape, in which material layer 1 is continuous and completely cut through along the entire line 2a, 2b of the L shape, starting from fold line 4 all the way to the end edge 1b of material web 1 shown at the top. Therefore rectangular sheet 3 can be bent out of the material layer along the line of the L shape 2, whereby it is pivoted about fold line 4.

A second sheet 3a is punched in a manner similar to sheet 3. The L-shaped punching, which represents the edge of the rectangular sheet 3a, however, is structured not in the form of a continuous punching (as in the case of sheet 3), but rather by a perforation punching. Sheet 3a is also divided into strips by multiple weakening lines 5a; these strips can be removed individually or several at a time, in order to use them for documentation purposes. Weakening lines 5 are also implemented by perforation punchings or the like.

On the underside of material layer 1, the adhesive coating is covered, in the region of sheet 3a, by a piece of film or another covering medium, for example a suitable paper, not shown, in order to prevent the strips that can be removed and are defined by the weakening lines 5a from permanently connecting with a container onto which the multi-wrap wrap-around label is pasted.

A third region of the multi-wrap wrap-around label serves as a closure part 8 and has a gripping tab 9 on the end side.

The multi-wrap wrap-around label has a length that amounts to slightly more than three times the circumference of the container to be labeled, in the example. The region 3a and sheet 3 are offset by approximately one container circumference u, i.e. offset by the distance u, where u is the circumference of the cross-section of container 6 (FIG. 2).

Material layer 1 is punched on one of its longitudinal sides, in such a manner that it has a broadened region 10, 10a in the region of sheets 3 and 3a, in each instance, in such a manner that the two aforementioned sheets 3 and 3a project beyond the edge line, in a way.

In order to prevent the two sheets 3 and 3a from permanently sticking together when the multi-wrap wrap-around label is applied to a container, and to prevent sheet 3 from sticking to closure part 8, the adhesive coating on the underside is eliminated in the region 3 and in the central region of closure part 8, or made ineffective by covering it up or overprinting it. The edge region of closure part 8, on which gripping tab 9 is situated, however, is provided with active adhesive on the underside in order to be able to close the multi-wrap wrap-around label—as will be explained below.

As an alternative to eliminating or covering the adhesive on the underside, the top side of sheets 3 and 3a can be provided with a coating that repels adhesive, in order to prevent the two sheets 3 and 3a from permanently sticking together when the multi-wrap wrap-around label is applied to a container, and to prevent sheet 3 from sticking to closure part 8.

FIG. 2, in a perspective view, shows a cylindrical container 6 that is labeled with the multi-wrap wrap-around label from FIG. 1, whereby the multi-wrap wrap-around label is partly pulled off. Labeling of container 6 takes place in such a manner that the edge of material layer 1, which lies on the right in FIG. 1, is pasted onto container 6, in such a manner that the left edge of material layer 1 extends parallel to the axial direction of container 6. The label is wrapped around container 6 three times. As a result, the parts coated with adhesive are firmly connected with container 6. Sheet 3a lies directly on container 6. Because sheet 3 is offset relative to sheet 3a by approximately one circumference distance u, or by slightly more than one circumference distance u, sheet 3 lies directly above sheet 3a. As a result of the measures described above, however, the two sheets 3 and 3a do not stick to one another. Closure part 8 lies directly above sheet 3. There is also no connection, at least no permanent connection, between closure part 8 and sheet 3. Because sheet 3 is cut off by means of the L-shaped punched line 2, and is connected with the rest of material layer 1 only by way of fold line 4, the sheet can be folded out of material layer 1. A rectangular sheet 3 is formed by the L-shaped punching.

In place of a rectangular sheet 3 or an L-shaped punching, the punched line can also have a different shape, but it must run at least from fold line 4 to edge 1b of material strip 1. A punched line that contains a circle section of another rounded form and/or a progression with corners, under the general conditions stated above, would also be possible.

As can be seen in FIG. 2, part of the multi-wrap wrap-around label, namely closure part 8, is unwound (opened). As a result of the measures described, there is no permanent adhesive connection between closure part 8 and sheet 3. There is also no adhesive connection between sheet 3a that lies against container 6 and sheet 3, so that in the end result, sheet 3 is free and can be torn off strip by strip. After one or more strips of sheet 3 have been torn off, the multi-wrap wrap-around label is closed off with closure part 8.

As can be seen in FIG. 2, sheet 3 projects as the result of the broadened region 10 of material layer 1, so that when the multi-wrap wrap-around label is wound up (closed), it can be seen whether or not sheet 3 is still present, in whole or in part. Sheet 3a also projects beyond the edge of closure part 8, because of broadened region 10a. Broadened region 10a is not visible in the drawing, however, because it is covered by the widened part 10 of sheet 3, as long as sheet 3 is still completely present.

FIG. 3 shows a second exemplary embodiment of a multi-wrap wrap-around label according to the invention, in a top view. In contrast to the embodiment shown in FIG. 1, the exemplary embodiment shown in FIG. 3 has a total of five sheets, of which one (sheet 3d) is punched with a perforation punching, while the other sheets 3, 3a, 3b, 3c are cut off from the material layer with an L-shaped continuous punching 2. The exemplary embodiment of FIG. 3 is intended to make clear that the number of sheets is not limited to two.

The multi-wrap wrap-around label is applied to a container by wrapping it around six times. In practice, it must be noted, in this connection, that the circumference of the container is increased by the material layer each time it is wound around, depending on the thickness of the material layer. In this connection, an offset of the sheets can be accepted, or the multi-wrap wrap-around label can be configured in such a manner that the distance between the sheets increases progressively, in accordance with the increase in the actual circumference. The size shown in the drawing therefore should not be understood to be a constant, but rather represents the actual circumference that can be calculated from the actual circumference, i.e. radius of the container plus the thickness of the layers that have already been applied. The multiple sizes u that are shown are therefore increased slightly from left to right, whereby the increase results from the increasing thickness resulting from the number of layers of the label wound onto the container that lie underneath.

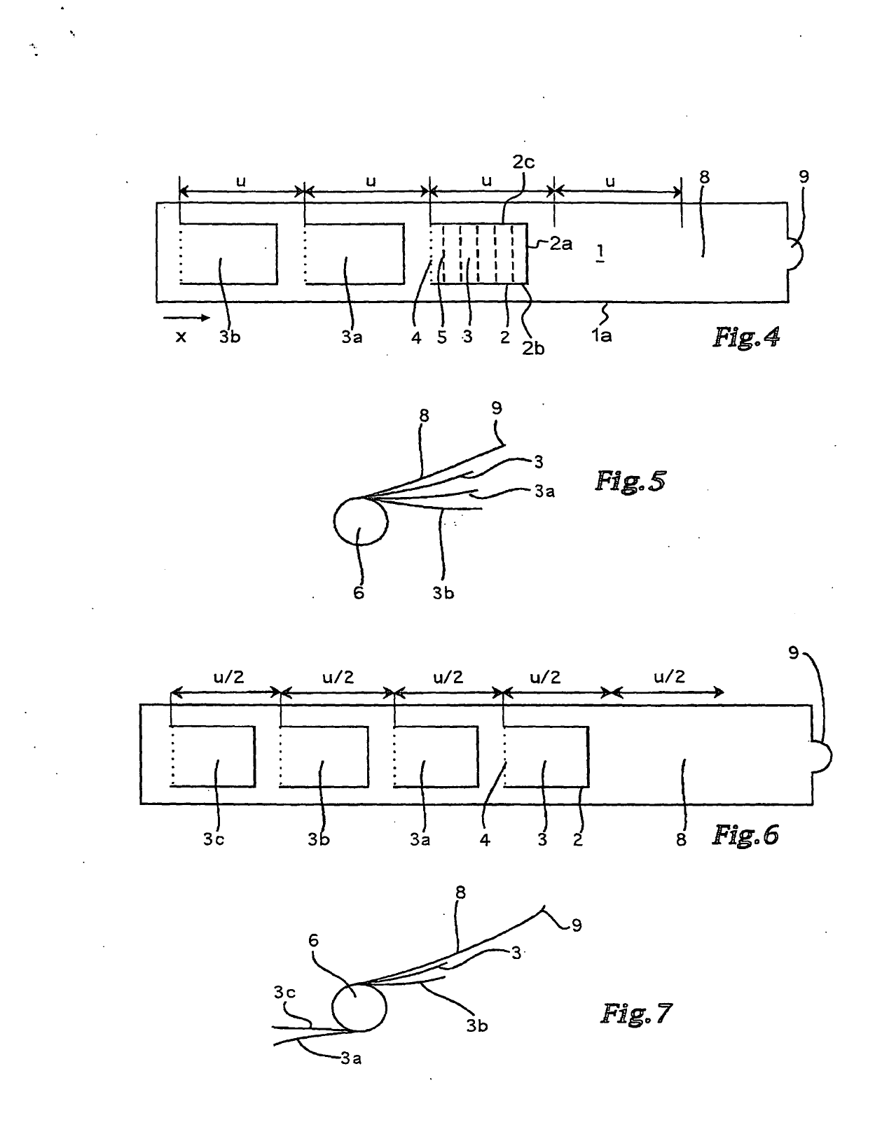

FIG. 4 shows a third exemplary embodiment of a multi-wrap wrap-around label according to the invention. The label, seen in a top view, consists of a material layer 1 that is coated with adhesive on its underside. Using a punching 2 that is approximately U-shaped in its rough outline, a rectangular sheet 3 is produced. Sheet 3 is connected with the remainder of material web 1 by way of a fold line 4. Sheet 3 is positioned on material layer 1 in such a manner that an edge strip towards the two longitudinal edges of material layer 1 remains, in each instance. Sheet 3 is divided into strip-shaped regions that can be removed separately or several at a time, by multiple weakening lines 5. Weakening lines 5 are implemented by perforation punchings in the example. Other types of weakening lines are also possible, as described in connection with FIG. 1.

The U shape has two second sections 2b, 2c that run parallel or almost parallel to one another, which are connected with one another at one end by way of a first section 2a that runs crosswise, i.e. perpendicular to them. Along the entire line 2b, 2a, 2c of the U shape, material layer 1 is completely cut through. The first section 2a of the U shape extends parallel or almost parallel to fold line 4. The sections 2b, 2c extend parallel or almost parallel to the side edges of material layer 1, which run in the longitudinal expanse direction x.

As can be seen in FIG. 4, two additional sheets 3a and 3b are provided, which have the same outline as sheet 3, but in contrast to sheet 3 are not divided by weakening lines. Sheets 3a and 3b remain in the multi-wrap wrap-around label in their entirety and permanently, and are generally imprinted with instructions for use or the like. The sheets, which are free of adhesive on the underside and on the top side, can be imprinted with information both on the top side and on the underside.

Finally, the multi-wrap wrap-around label has a closure part 8 that is provided with a gripping tab 9 at the end side. In order to prevent closure part 8 from permanently sticking to sheet 3a when the multi-wrap wrap-around label is applied to a container, the adhesive coating on the underside is eliminated in the central region of closure part 8, or made ineffective by covering or imprinting it. The edge region of closure part 8, on which gripping tab 9 is situated, however, is provided with active adhesive on the underside, in order to be able to close the multi-wrap wrap-around label—as is explained further below.

As an alternative to covering the adhesive on the underside of closure part 8, the top side of sheet 3 can be provided with a coating that repels adhesive, for example a silicone coating.

The multi-wrap wrap-around label has a length that amounts to slightly more than four times the circumference of the container to be labeled, in the example. Sheets 3, 3a, and 3b are offset relative to one another by approximately one container circumference, in each instance.

FIG. 5, in a top view, shows a cylindrical container 6 that is labeled with the multi-wrap wrap-around label shown in FIG. 1. Labeling of container 6 takes place in such a manner that the edge of material layer 1 that lies to the left in FIG. 4 is pasted onto container 6, in such a manner that the left edge of material layer 1 extends in the axial direction of the container. The label is wrapped around container 6 four times, whereby the parts coated with adhesive are firmly connected with container 6. Sheet 3b lies directly on container 6. Because sheet 3a is offset by one circumference distance u relative to sheet 3b, sheet 3a lies directly above sheet 3b. In the same manner, sheet 3 lies on sheet 3a. Because sheets 3a and 3b, as explained above, are free of adhesive both on their underside and on their top side, they do not stick to one another. Closure part 8 lies directly above sheet 3. There is also no adhesive connection, at least no permanent adhesive connection, between closure part 8 and sheet 3. Because the sheets are separated from material layer 1 by a punching 2 that is roughly U-shaped in outline, and remain connected with material layer 1 only along fold line 4, sheets 3, 3a, 3b can be folded out of material layer 1.

FIG. 5 shows the multi-wrap wrap-around label in the open state, which means that closure part 8 has been raised by pulling on gripping tab 9, and sheets 3, 3a, 3b were thereby fanned open. As can be seen, a small book or booklet has been created, in which information can be presented on the two sheets 3a and 3b, both on the front and on the back, i.e. a total of four pages. The third sheet 3 serves to make available tear-off strips for documentation purposes. After the information has been read and/or after a strip has been removed, the “booklet” can be closed again, because—as has already been mentioned—the edge region of the closure part is provided with adhesive on the underside, in the vicinity of gripping tab 9.

In a modification of the exemplary embodiment of FIG. 4 that has been described, several or all of the sheets can be equipped with weakening lines, like sheet 3, or all the sheets can also be configured as pure information sheets like sheets 3a and 3b. Also, a total of more than three or fewer than three sheets can be provided.

FIG. 6 shows a fourth exemplary embodiment of a multi-wrap wrap-around label according to the invention, in a top view. The label, which is shown in a top view, consists of a material layer 1 that is coated with adhesive on its underside. Four rectangular sheets 3, 3a, 3b, and 3c, which are connected with the remainder of material web 1 by way of a fold line 4, in each instance, are produced by means of four punchings 2 that are approximately U-shaped in a rough outline. Sheets 3, 3a, 3b, and 3c are positioned on material layer 1 in such a manner that an edge strip towards the two longitudinal edges of the material layer 1 remains, in each instance.

Sheets 3, 3a, 3b, and 3c remain in the multi-wrap wrap-around label in their entirety and permanently, and are generally imprinted with instructions for use or the like. The sheets, which are free of adhesive on the underside and the top side, can be imprinted with information both on the top side and on the underside.

Finally, the multi-wrap wrap-around label has a closure part 8 that is provided with a gripping tab 9 on the end side. In order to prevent closure part 8 from permanently sticking to sheet 3a when the multi-wrap wrap-around label is applied to a container, the adhesive coating on the underside is eliminated in the central region of closure part 8, or made inactive by covering or overprinting it. The edge region of closure part 8, on which gripping tab 9 is situated, however, is provided with active adhesive on the underside in order to be able to close the multi-wrap wrap-around label.

As an alternative to covering the adhesive on the underside of closure part 8, the top side of sheet 3 could be provided with a coating that repels adhesive.

The multi-wrap wrap-around label has a length that amounts to slightly more than three times the circumference of the container to be labeled in the example. In contrast to the exemplary embodiments described above, sheets 3, 3a, 3b, and 3c are offset from one another by approximately half a container circumference u/2, in each instance.

FIG. 7, in a top view, shows a cylindrical container 6, that is labeled with the multi-wrap wrap-around label shown in FIG. 6. Labeling of container 6 takes place in such a manner that the edge of material layer 1 that lies on the left in FIG. 4 is pasted onto container 6, in such a manner that the left edge of material layer 1 extends in the axial direction of the container. The label is wrapped around container 6 three times, whereby the parts coated with adhesive are firmly connected with container 6. Sheet 3c lies directly on container 6. Because sheet 3b is offset by half a circumference distance u/2 relative to sheet 3c, sheet 3b lies diametrically opposite sheet 3c. Sheet 3a lies on top of sheet 3c because it is offset from it by the entire circumference (u/2+u/2). Sheet 3 lies on sheet 3b because it is offset by an entire circumference relative to it. Finally, the closure part lies on top of the sheet 3. Because it has a length of an entire circumference, it covers all sheets 3, 3a, 3b, 3c in the closed state.

Because sheets 3a and 3b, as explained above, are free of adhesive both on their underside and on their top side, they do not stick to one another. Closure part 8 lies directly above sheet 3 and sheet 3a. Again, there is no adhesive connection, at least no permanent adhesive connection, between closure part 8 and sheet 3. Because the sheets are separated from material layer 1 by a punching 2 that is roughly U-shaped in outline, and remain connected with material layer 1 only along fold line 4, sheets 3, 3a, 3b, 3c can be folded out of material layer 1.

FIG. 7 shows the multi-wrap wrap-around label in the open state, which means that closure part 8 has been raised by pulling on gripping tab 9, and sheets 3, 3a, 3b, 3c were thereby fanned out. As can be seen, two booklets have been formed by the special offset of the sheets by u/2. After the information has been read and/or a strip has been removed, the “booklet” can be closed again, because—as has already been mentioned—the edge region of the closure part is provided with adhesive on the underside, in the vicinity of gripping tab 9.

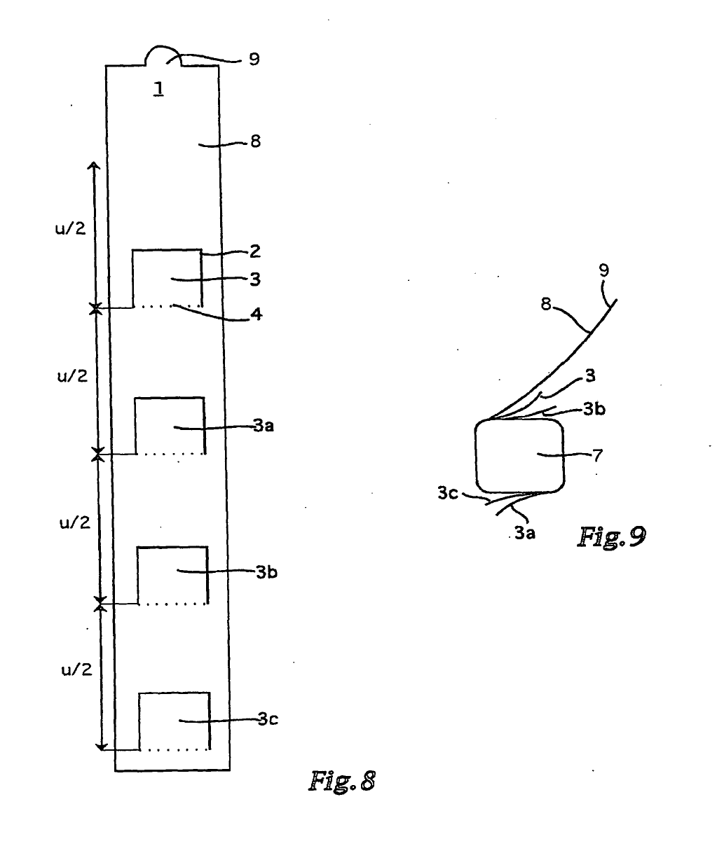

FIG. 8 shows a fifth exemplary embodiment of a multi-wrap wrap-around label according to the invention, in a top view. The label, shown in a top view, consists of a material layer 1 that is coated with adhesive on its underside. Four rectangular sheets 3, 3a, 3b, and 3c, which are connected with the remainder of the material web 1 by way of a fold line 4, in each instance, are produced by means of four punchings 2 that are approximately U-shaped in a rough outline. Sheets 3, 3a, 3b, and 3c are positioned on material layer 1 in such a manner that an edge strip towards the two longitudinal edges of material layer 1 remains, in each instance.

Sheets 3, 3a, 3b, and 3c remain in the multi-wrap wrap-around label in their entirety and permanently, and are generally imprinted with instructions for use or the like. The sheets, which are free of adhesive on the underside and the top side, can be imprinted with information both on the top side and on the underside.

Finally, the multi-wrap wrap-around label has a closure part 8 that is provided with a gripping tab 9 on the end side. In order to prevent the closure part 8 from permanently sticking to sheet 3a when the multi-wrap wrap-around label is applied to a container, the adhesive coating on the underside is eliminated in the central region of closure part 8, or made inactive by covering or overprinting it. The edge region of closure part 8, on which gripping tab 9 is situated, however, is provided with active adhesive on the underside, in order to be able to close the multi-wrap wrap-around label.

As an alternative to covering the adhesive on the underside of closure part 8, the top side of sheet 3 can be provided with a coating that repels adhesive.

The multi-wrap wrap-around label has a length that amounts to slightly more than three times the circumference of the container to be labeled, in the example. Sheets 3, 3a, 3b, and 3c are offset relative to one another by approximately half a container circumference u/2, in each instance. Sheets 3, 3a, 3b, and 3c have a length of not quite one-fourth of the circumference of the container, measured from fold line 4, in the longitudinal direction of the multi-wrap wrap-around label.

FIG. 9, in a top view, shows a container 7 that is labeled with the multi-wrap wrap-around label shown in FIG. 8. The cross-section of container 7 is square in its basic shape, with rounded-off corners, in each instance. Alternatively, the cross-section could also be rectangular with rounded-off corners, or without essentially rounded-off corners. Labeling of container 7 takes place in such a manner that the edge of material layer 1 that lies at the bottom in FIG. 8 is pasted onto container 7, in such a manner that the lower edge of material layer 1 extends in the axial direction of the container. The label is wrapped around container 7 three times. As a result, the parts coated with adhesive are firmly connected with container 7. Sheet 3c lies directly on container 7. Because sheet 3b is offset by half a circumference distance u/2 relative to sheet 3c, sheet 3b lies diametrically opposite sheet 3c. Sheet 3a lies on top of the sheet 3c because it is offset from it by an entire circumference (u/2+u/2). Sheet 3 lies on sheet 3b because it is offset by an entire circumference relative to it. Finally, the closure part lies on top of sheet 3. Because it has a length of an entire circumference, it covers all sheets 3, 3a, 3b, 3c in the closed state.

Because sheets 3a and 3b, as explained above, are free of adhesive both on their underside and on their top side, they do not stick to one another. Closure part 8 lies directly above sheet 3 and sheet 3a. Again, there is no adhesive connection, at least no permanent adhesive connection, between closure part 8 and sheet 3. Because the sheets are separated from material layer 1 by a punching 2 that is roughly U-shaped in outline, and remain connected with material layer 1 only along fold line 4, sheets 3, 3a, 3b, 3c can be folded out of material layer 1. FIG. 9 shows a container that is square in cross-section, which is labeled with a multi-wrap wrap-around label from FIG. 8, whereby the multi-wrap wrap-around label is partly pulled off.

FIG. 9 shows the multi-wrap wrap-around label in the open state, which means that closure part 8 has been raised by pulling on gripping tab 9, and sheets 3, 3a, 3b, 3c were thereby fanned out. As can be seen, two booklets have been formed by the special offset of the sheets by u/2. Because sheets 3, 3a, 3b, 3c extend over barely one-fourth of the total circumference in the circumference direction, the individual sheets lie on the flat side walls of the square container. After the information has been read, the “booklet” can be closed again, because—as has already been mentioned—the edge region of the closure part is provided with adhesive on the underside, in the vicinity of gripping tab 9.

In summary, the present invention describes a multi-wrap wrap-around label that is able to make a plurality of wings and/or documentation parts available. The wing parts can be provided with information on one or both sides. The documentation parts are also provided with information, and are configured to be removable. By wrapping a container with a proposed label, multiple times, a structure is formed that is able to accommodate a plurality of wing and/or documentation parts on a small container. Furthermore, a container is described that is provided with the proposed label. A container labeled in this manner can be equipped with a large amount of information.

Although several embodiments of the present invention have been shown and described, it is to be understood that many changes and modifications may be made thereunto without departing from the spirit and scope of the invention as defined in the appended claims.

What is claimed is:

1. A multi-wrap wrap-around label for labeling a container comprising at least one material layer having an underside and a top side, said underside being adhesive at least at selected points, said top side carrying information, wherein said at least one material layer'has at least one punched-out sheet foldable out of the at least one material layer.

2. The multi-wrap wrap-around label according to claim 1, wherein the at least one punched-out sheet comprises a plurality of sheets disposed at reciprocally approximately regular intervals.

3. The multi-wrap wrap-around label according to claim 1, wherein the at least one sheet is connected with the at least one material layer by way of a fold line extending crosswise to a longitudinal direction of the at least one material layer.

4. The multi-wrap wrap-around label according to claim 1, wherein the at least one sheet is rectangular.

5. The multi-wrap wrap-around label according to claim 1, wherein the at least one material layer in a region of the at least one sheet is not adhesive.

6. The multi-wrap wrap-around label according to claim 1, wherein the top side in a region of the at least one sheet is covered with a coating that repels adhesive.

7. The multi-wrap wrap-around label according to claim 1, wherein the at least one sheet has at least one weakening line, the at least one sheet being adapted to be torn off along the at least one weakening line.

8. The multi-wrap wrap-around label according to claim 5, wherein the at least one material layer in the region of the at least one sheet has a broadened region.

9. A cylindrical or prismatic container labeled with a multi-wrap wrap-around label, said multi-wrap wrap-around label comprising at least one material layer having an underside and a top side, said underside being self-adhesive at least at selected points, said top side carrying information, wherein said at least one material layer has at least one punched-out sheet foldable out of the at least one material layer.

10. The container according to claim 9, wherein the at least one punched-out sheet comprises a plurality of sheets disposed at reciprocally approximately regular intervals.

11. The container according to claim 10, wherein the container has a circumference and the intervals approximately have the value u/n, where u is the circumference of the container and n is a whole number from 1 to 6.

12. The container according to claim 9, wherein the at least one sheet is connected with the at least one material layer by way of a fold line extending parallel to an axial direction of the container.

13. The container according to claim 9, wherein the at least one sheet is rectangular.

14. The container according to claim 9, wherein the at least one material layer in a region of the at least one sheet is not adhesive.

15. The container according to claim 14, wherein the top side in the region of the at least one sheet is covered with a coating that repels adhesive.

16. The container according to claim 9, wherein the at least one sheet has at least one weakening line, the at least one sheet being adapted to be removed along the at least one weakening line.

17. The container according to claim 14, wherein the at least one material layer in the region of the at least one sheet has a broadened region.
